(19) United States
(12) Patent Application Publication
(10) Pub. No.: US 2003/0066347 A1
(43) Pub. Date: Apr. 10, 2003

(54) Chemical injection pulse generator

(76) Inventor: Mark Goloby, Houston, TX (US)

Correspondence Address: BAKER BOTTS, LLP, 910 LOUISIANA, HOUSTON, TX, 77002-4995, US

(21) Appl. No.: 10/268,532

(22) Filed: Nov. 20, 2002

Related U.S. Application Data
(63) Continuation of application No. 09/971,997, filed on Oct. 5, 2001.

(51) Int. Cl. G01F 23/36; G01F 23/52

(52) U.S. Cl. 73/313; 340/623

(57) ABSTRACT

A small volume flow measurement apparatus is described, together with a method for measuring a small volume flow. The small volume flow measurement apparatus is composed primarily of a holding tank, a metering reservoir and an electronics module. Flow is calculated based on the number of times the metering reservoir is filled or emptied.

### FIELD OF THE INVENTION

The present invention relates to the precise measurement of fluids. Specifically, the present invention relates to the use of a tank to precisely measure a fluid for injection.

### BACKGROUND OF THE INVENTION

Small volume flow measurement systems are frequently used in the chemical, water treatment, and other industries to measure small amounts of a fluid injected into larger fluid flows. Examples of these applications include injection of inhibitors into reactive monomers, concentrated dye solutions or corrosion inhibitors into chemical products, and caustic or acid into a solution to be buffered.

These small volume flow measurement applications are traditionally performed by a number of different systems. One common small volume measurement system is the chemical injection pump/sight glass system. The injection pump is most often a reciprocating positive displacement pump driven by a gas such as air. Adjusting the amount of air pressure delivered to the pump adjusts the time delay valve, which increases or decreases how quickly the pump cycles. Most often, these injection pumps may be further adjusted by increasing or decreasing the “stroke” or the amount of liquid pumped per cycle. Typically, the volume delivered by the injection pump is measured with a sight glass. The sight glass is connected to the suction side of the injection pump and then filled with the fluid to be injected. An operator may use the pump to remove the fluid to be injected from the sight glass and time the removal of fluid from the sight glass in order to gauge the flow rate being delivered by the injection pump. The operator may then adjust either the speed or stroke of the pump to achieve the desired delivery rate. However, the reciprocating positive displacement pump may be difficult to adjust to achieve the desired rate because of pump efficiency variations, variable stroke length, changes in line pressure or static head, line debris, or variations in the density of the fluid to be injected due to the presence of water or other contaminants. In addition, measurements taken by a sight glass are highly variable and unreliable. Further, because of the size of the pump chamber within the chemical injection pump, it is often difficult to achieve very small addition rates, resulting in loss of high-value injected fluid or poor process control because of overdosing. Also, because there is no electronic measurement of the actual flow delivered with this traditional injection pump method, the operator typically had no effective method of determining how much of the fluid to be injected was actually delivered.

Another method often used to measure small volumes is to propel the fluid to be injected through a more traditional flow meter. Examples of these flow meters include pitot tubes, venturi meters, orifice meters, turbine meters, and coriolis meters. In these applications, the small volume fluid is pumped through one of these meters to measure the flow, and the flow is controlled through the use of a manual or control valve. These applications suffer from a number of deficiencies. First, it is difficult to regulate the small flow needed with control and manual valves, as the valve must often operate at a near-seated condition, a condition where the valve is only open a fraction of its total range. Actual control of flowing fluids in such a near-seated condition is difficult. Because the valve is nearly closed, it may effective “dead-head” the pump, increasing energy losses to friction and heating the fluid, a condition that may degrade the injected fluid. In addition, many traditional metering systems do not measure effectively at the extremely low flow rates needed for these injected fluids, sometimes as low as one gallon per day. This may result in overdosing or under-dosing, and may result in poor process control. Timers that turn pumps off and on to reduce the overall flow rate have also been used with less than effective results, as this method most often results in part of the fluid being overdosed and part under-dosed. Further, those traditional types of metering systems that will operate at flow rates close to those desired by the operator for these injected fluids are often very expensive and still may not reach as low a flow rate as is desired by the operator. Finally, all of these meters must be regularly calibrated and adjusted.

What is needed is a low cost system capable of measuring a low flow rate of liquid, often less than one gallon per day. The system should be easy to maintain and require a minimum amount of calibration and adjustment. Further, the system should be capable of communicating with other monitoring equipment such as SCADA and other PLC-type environments, as well as wireless data transfer networks.

### SUMMARY OF THE INVENTION

Accordingly, a method and apparatus for measuring small volume flows is disclosed herein. One embodiment of the present invention is drawn to a flow measuring apparatus composed of a metering reservoir with a reservoir outlet port and a reservoir inlet port. A control valve is located so as to be capable of allowing or stopping flow to the metering reservoir. The flow measuring apparatus further has a liquid level sensor with an upper limit switch and a lower limit switch. An electronics module is in communication with the upper limit switch, the lower limit switch and the control valve.

Another embodiment of the present invention is drawn to a flow measuring apparatus composed of a metering reservoir with a reservoir outlet port and a reservoir inlet port. A tank outlet conduit is located so as to be able to conduct fluid to the metering reservoir. A control valve is located so as to be capable of allowing or stopping flow to the metering reservoir. The flow measuring apparatus further has a liquid level sensor with a lower limit switch. It further contains a paddlewheel. The paddlewheel has a central pivot point and paddles, with the paddles radiating from the central pivot point. The paddlewheel is located within the tank outlet conduit and is capable of rotating in response to fluid flow through the tank outlet conduit. An electronics module is in communication with the paddlewheel, the lower limit switch and the control valve.

In another embodiment of the present invention, a method for measuring a small volume flow is disclosed. In this embodiment, the flow measuring apparatus of the first embodiment is provided. Further, the fluid to be injected is provided within the holding tank. The control valve is opened to allow fluid flow from the holding tank and the metering reservoir. The metering reservoir is filled until the upper limit switch is activated. The control valve is then closed and the fluid emptied from the metering reservoir until the level is reduced to the lower limit switch. The amount of fluid emptied from the metering reservoir is calculated.

### DESCRIPTION OF THE DRAWINGS

FIG. 1 is a schematic of the apparatus for measuring the fluid to be injected.

FIG. 2 is a flow chart of the actions taken by the apparatus.

FIG. 3 is a schematic of a float mechanism in one embodiment of the present invention.

FIG. 4 is a schematic of a float mechanism and paddlewheel in an alternative embodiment of the present invention.

### DETAILED DESCRIPTION OF THE INVENTION

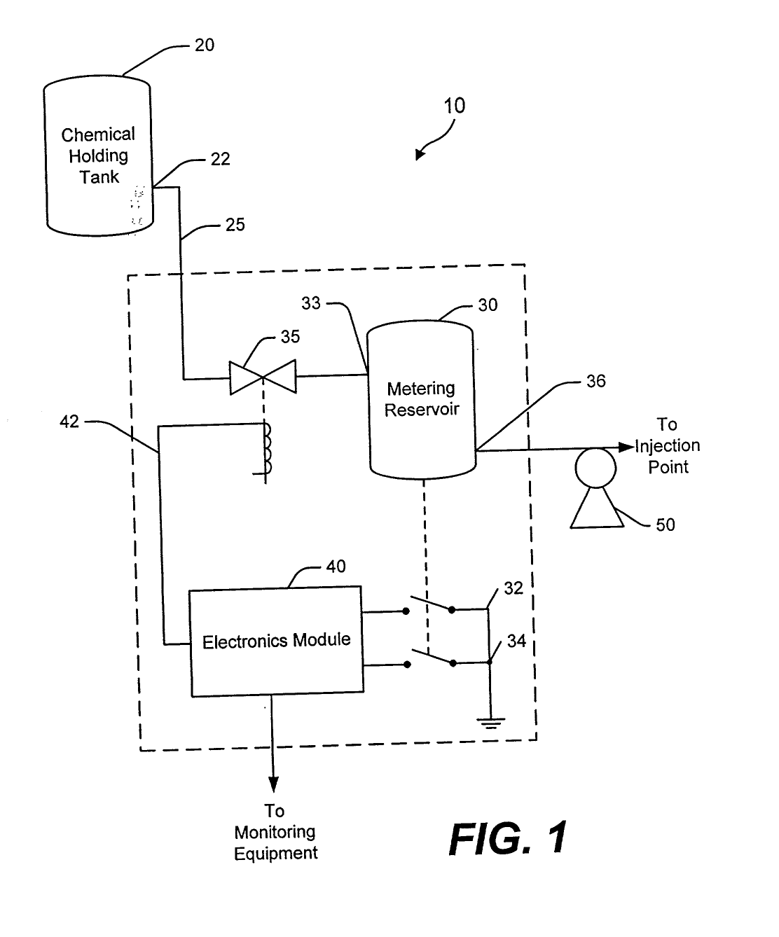

The present invention describes an apparatus and method for delivering a small volume of a fluid to be injected to a second fluid of a much larger volume. Often, less than one gallon per day of the fluid to be injected is transferred to the second fluid. The second fluid may be a liquid or a gas. In one embodiment of the present invention, the chemical injection pulse generator (“CIPG”) is show in FIG. 1. CIPG 10 is primarily composed of two pieces of equipment, metering reservoir 30 and electronics module 40. The fluid to be injected is typically contained in chemical holding tank 20. The fluid to be injected may be nearly any liquid or slurry that is capable of flow. Chemical holding tank 20 may be a tank, drum, or any other container acceptable for use in storage of the fluid to be injected. Depending on the type of fluid to be injected, it may be desirable to provide an inert or dry atmosphere within chemical holding tank 20, such as through a nitrogen or air blanket. Further, chemical holding tank 30 may be insulated, heat traced or steam jacketed for viscous fluids to be injected. The fluid to be injected may be transferred from chemical holding tank 20 through tank outlet conduit 25 to metering reservoir 30. The fluid to be injected is discharged from chemical holding tank 20 through chemical holding tank outlet port 22. Chemical holding tank outlet port 22 is generally on or near the bottom of chemical holding tank 20 in order to fully drain chemical holding tank 20, when required, and also to provide as much liquid head throughout CIPG 10 as possible. However, the location of chemical holding tank outlet port 22 may be adjusted based on local conditions. Chemical holding tank 20 should be constructed of a material compatible with the fluid to be injected.

Metering reservoir 30 is a tank with known volume characteristics. Metering reservoir 30 should be sized such that its volume is generally between approximately 1% and 100% of the volume of injected fluid transferred in one day, although one of skill in the art will appreciate that greater or lesser volumes may also be chosen depending on need. While metering reservoir 30 is typically of size and configuration to measure liquid volumes of approximately one pint, it may be quart-sized or gallon-sized or more. Metering reservoir 30 may be of nearly any configuration, although cylindrical or rectangular configurations are preferred over spherical or less symmetrically shaped reservoirs for ease of volume calculation and installation. Further, metering reservoir 30 may be composed of any material that will not react with the fluid to be injected and has the requisite strength and durability for the desired environment. Examples useful of acceptable materials in certain chemical services include carbon steel, stainless steel, fiberglass, polypropylene and polyethylene.

Fluid may be transferred in and out of metering reservoir 30 through reservoir inlet port 33 and reservoir outlet port 36, respectively. Fluid transferred through tank outlet conduit 25 enters metering reservoir tank 30 through reservoir inlet port 33. The location of reservoir inlet port 33 is not critical, although it should be located far enough from upper limit switch 32 and lower limit switch 34, described below, such that it does not interfere with the associated level determinations. It is preferred that reservoir inlet port 33 be located at or near the top of metering reservoir 30, above the activation level of upper limit switch 32, although this is not required. Reservoir outlet port 36 should be located at or near the bottom of metering reservoir 30, and below the activation level of lower limit switch 34. Reservoir outlet port 36 should be further located such that it does not otherwise interfere with either upper limit switch 32 or lower limit switch 34. Liquid is discharged through outlet port 36 through reservoir outlet conduit 38 to pump 50. In one alternative embodiment, metering reservoir 30 has a breather vent located on the top surface to prevent vapor retention in the system during filling. This breather vent should be installed in such a way as to reduce fluid leakage.

Upper limit switch 32 and lower limit switch 34 are designed to transfer information regarding the fluid level in metering reservoir 30 to electronics module 40. Upper limit switch 32 is activated when a rising fluid reaches its activation or “set” point. Lower limit switch 34 is activated when a draining fluid reaches its set point. It is advisable to establish the set point for upper limit switch 32 near the top of metering reservoir 30 to maximize the volume of metering reservoir 30 available for use. Similarly, it is advisable to establish the set point for lower limit switch 34 near the bottom of metering reservoir 30 to maximize the volume of metering reservoir 30 available for use. It is important to determine the volume of liquid contained in metering reservoir between the set point of the lower limit switch and the set point of the upper limit switch, within a known error tolerance. This error tolerance should be as small as is reasonably possible. Typically, this amount of error in measuring volume is less than 1%, often less than 0.1% of the total volume.

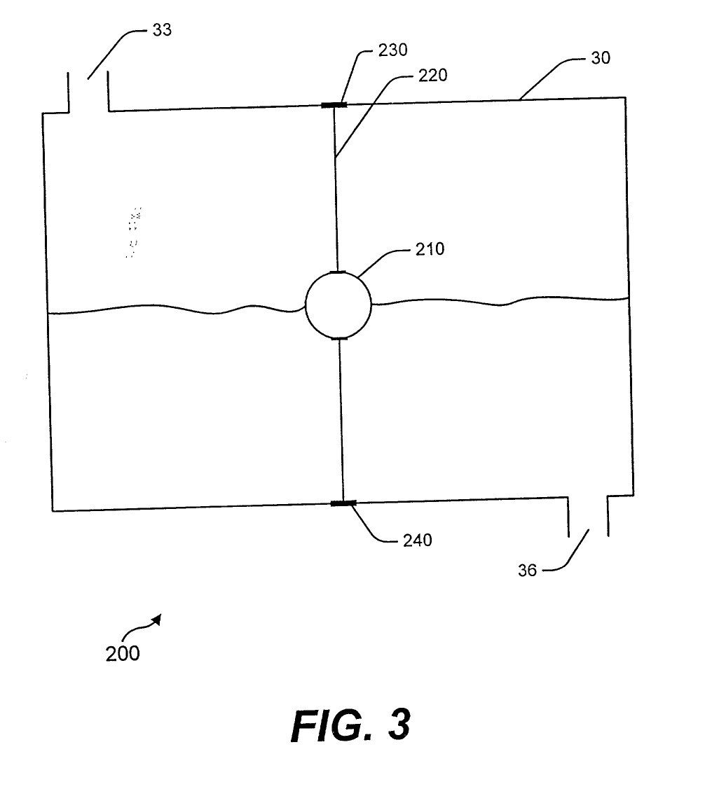

In one embodiment of the present invention, upper limit switch 32 and lower limit switch 34 are contained within an integrated float switch system. With integrated float system 200, as shown in FIG. 3, float 210 is buoyant in the fluid to be injected and is suspended within metering reservoir 30. The float traverses guide 220 as the fluid level within metering reservoir 30 rises or falls. Guide 220 may be any mechanism that allows such movement such as a wire, cylinder or bar. All parts of integrated float system 200 that are in contact with the fluid to be injected should be compatible with the fluid to be injected. When liquid is transferred to metering reservoir 30 from chemical holding tank 20 through tank outlet conduit 25, it fills metering reservoir 30. The float within metering reservoir 30 rises until it reaches the top of metering reservoir 30. When the float touches the top of metering reservoir 30, upper limit switch 32 is activated by the float making electrical contact with upper contact point 230 at the top of metering reservoir 30, indicating that metering reservoir 30 is full. When metering reservoir 30 is emptied, the float within metering reservoir 30 sinks until it reaches the bottom of metering reservoir 30 and activates lower limit switch 34 by making electrical contact with bottom contact point 240 at the bottom of metering reservoir 30, indicating that metering reservoir 30 is empty. Other mechanisms are possible, e.g., ultrasonic level detectors, magnetic switches and electrical transducers, but these other mechanisms must provide level information for at least two points during the filling and emptying of metering reservoir 30.

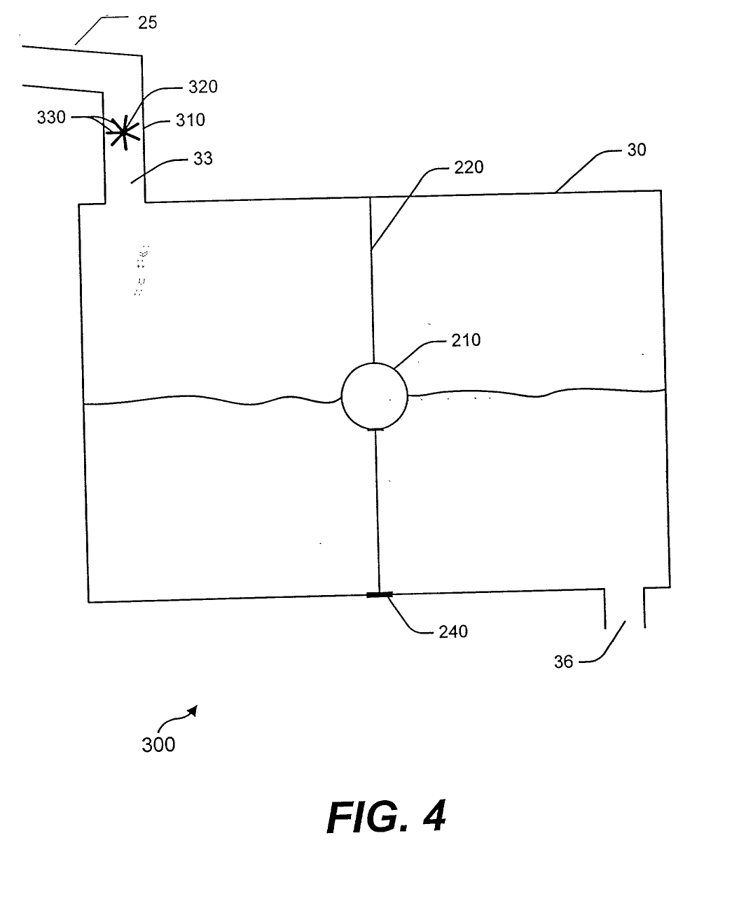

In an alternative embodiment, shown in FIG. 4, paddlewheel alternative 300 is shown where upper limit switch 32 may be eliminated. Instead, paddlewheel 310 is used to establish that metering reservoir 30 had reached its upper set point. Paddlewheel 310 is a freewheeling flow measurement device generally including central rotational pivot 320 that is connected to paddles 330. As fluid is transferred through tank outlet conduit 25, the fluid contacts paddles 330, causing them to rotate about rotational pivot 320. The rate of rotation of paddlewheel 310 is proportional to the flow rate of the fluid through tank outlet conduit 25. Paddlewheel 310 is capable of sending a signal to electronics module 40 indicating the number of rotations of paddlewheel 310 caused by the fluid into metering reservoir 30. Paddlewheel 310 is shown within a vertical section of tank outlet conduit 25 but could be located in a horizontal section of tank outlet conduit 25 as well. As another alternative, paddlewheel 310 may be used in conjunction with upper limit switch 32, where either upper limit switch 32 or paddlewheel 310 is used for the upper volume limit and the other used as a double-check or backup determination of level within metering reservoir 30.

Upon activation, upper limit switch 32 and lower limit switch 34 are designed to send a signal to electronics module 40 indicating the status of filling. Electronics module 40 may be any combination of electronic or digital components designed to receive signals from upper limit switch and lower limit switch 34 and conduct certain preprogrammed actions as designated by the operator. For instance, as shown in the embodiment depicted in FIG. 1, when electronics module 40 receives a signal from upper limit switch 32, it sends a signal through output signal transfer 42 to a device designed to activate control valve 35, such as a solenoid. The solenoid is capable of opening or closing control valve 35. Control valve 35 then may allow or stop fluid flow from chemical holding tank 20 to metering reservoir 30. Upon receiving a signal from upper limit switch 32, electronics module 40 directs control valve 35 to close, stopping flow from chemical holding tank 20 to metering reservoir 30. Metering reservoir 30 may then be emptied through reservoir outlet port 36. At the point that lower limit switch 34 is activated, a signal is sent from electronics module 40 through output signal transfer 42, opening control valve 35 and allowing fluid flow from chemical holding tank 20 to metering reservoir 30. In the alternative embodiment shown in FIG. 4, electronics module 40 responds to a signal from lower limit switch as described for FIG. 1. In addition, electronics module 40 is configured so as to count the revolutions made by paddlewheel 310 and also to correlate these revolutions with the flow of fluid into metering reservoir 30. When the total volume measured by paddlewheel 310 reaches a set volume, normally the volume of metering reservoir 310 but alternatively a lesser volume, electronics module directs control valve 35 to close, stopping flow to metering reservoir 30.

In addition to opening and closing control valve 35, electronics module 40 may also be designed to count the number of times that upper limit switch 32, lower limit switch 34, or both are activated (hereinafter referred to as “switch count”). Alternatively, electronics module 40 may simply pass this information to monitoring equipment located separately, to calculate the switch count. By using the known volume of metering reservoir 30 and the switch count, either electronics module 40 or the separately located monitoring equipment may then calculate the amount of fluid to be injected that has been transferred from metering reservoir 30 through reservoir outlet port 36. Similarly, when paddlewheel 310 is used, the total revolutions of paddlewheel 310 may be used to calculate the amount of fluid transferred through metering reservoir 30. Information transferred from electronics module 40 to separately located monitoring equipment is typically accomplished through a dc voltage signal, although a 4-20 pulse may also be used. The separately located monitoring equipment may be of any configuration, but a PLC or SCADA environment is typically used. Typically, electronics module 40 is supplied with a 12-volt dc power supply. Such 12 volts may be provided via solar panel connected to a battery or providing current directly, current converted to a 12-volt dc power level, battery, or such other configuration as desired.

Fluid that is transferred from reservoir 30 through reservoir outlet port 36 is delivered to pump 50. Pump 50 then injects the fluid into the second stream. CIPG 10 may include other devices useful to accomplish its purposes. For instance, a check valve may be provided between chemical holding tank 20 and metering reservoir 30 and/or between metering reservoir 30 and pump 50 to assure that second fluid does not flow back into CIPG 10. In addition, isolation valves may be provided within CIPG 10 for maintenance purposes. Filters or filtering assemblies also may be used within CIPG 10 to remove debris from the fluid to be injected prior to injection into the higher volume fluid. A secondary outlet with a removable plug may be included on metering reservoir 30 to facilitate cleaning.

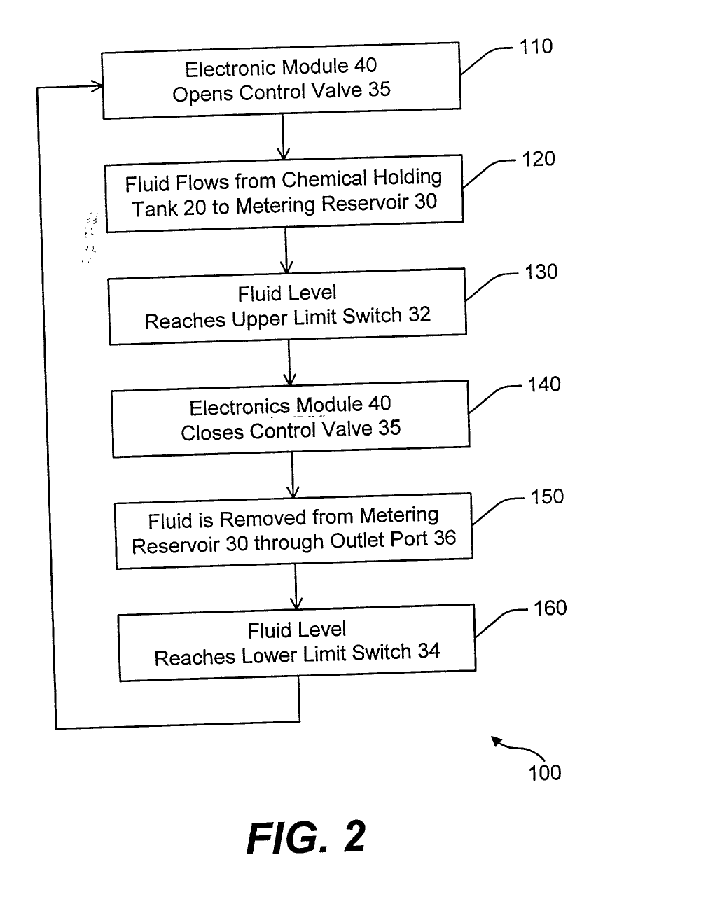

FIG. 2 is a flow chart, depicting generally measuring process 100 that reflects the actions taken by CIPG 10 in measuring the fluid to be injected. When the measuring process begins, as shown in block 110, electronics module 110 directs that control valve 35 be opened. As described above, this is typically accomplished by communicating with a solenoid valve that provides the motive force to open control valve 35. As described in block 120, fluid then flows from chemical holding tank 20 to metering reservoir 30, filling metering reservoir 30. When the fluid to be injected reaches upper limit switch 32, as shown in block 130, the upper limit switch 32 communicates this information to electronics module 40. Electronics module 40 then directs control valve 35 to close, as indicated in block 140. The fluid to be injected is then removed from metering reservoir 30 through outlet port 36, as depicted in block 150, typically with the use of pump 50. When the draining fluid reaches lower limit switch 34, lower limit switch 34 then communicates this information to electronics module 40 as shown in block 160. Electronics module 34 then directs control valve 35 to open as shown in block 110, beginning the entire process anew.

In one embodiment of the present invention, the time period between lower limit switch 34 activation and upper limit switch 32 activation, or, alternatively, the time period between lower limit switch 34 activation and when the information generated by paddlewheel 310 indicates the total volume has been reached, is gathered to calculate the level of fluid within chemical holding tank 20. Bernoulli's equation states that:

p+½ρV²+ρgh=constant

Where p is the pressure at a given point, ρ is the density of the fluid, V is the velocity, h is the elevation, and g is the gravitational acceleration. Thus, for two points in a system:

p₁+½ρV₁²+ρgh₁=½ρV₂²+ρgh₂+p₂

Where point 1 is chemical holding tank outlet port 22 and point 2 is reservoir inlet port 33. The pressure at point 1 will be equal to the height of the column of liquid in chemical holding tank 20 times the density and the gravitational constant. Further, because any fluid velocity at point 1 would be miniscule in comparison to the velocity at point 2, and assuming that any pressure drop between point 1 and point 2 would be small in comparison to the height of the liquid column in chemical holding tank 20, this equation would simplify to:

gh₁=½V₂²

Therefore, the speed at which metering reservoir 30 fills is proportional to the square root of the height of the column of liquid in chemical holding tank 20. Electronics module 40 or the monitoring equipment may be programmed or configured to include information regarding the volume information of chemical holding tank 20. Based on the known volume information of metering reservoir 30, the time it takes to fill metering reservoir 30, either as determined from time period between activation of lower limit switch 34 and upper limit switch 32 or by paddlewheel 310, electronics module 40 or the monitoring equipment may calculate the volume of fluid within chemical holding tank 20. In most situations, the assumptions made in the Bernoulli equation example above are only approximations and the operator may determine the relationship between filling time of metering reservoir 30 and the volume in chemical holding tank 20 experimentally, instead of theoretically. Alternatively, the operator may choose to simply rely on prior experience or rough estimation of the relationship between the filling time of metering reservoir 30 and the volume in chemical holding tank 20. Further, successive measurements of the time periods between upper limit switch activation and lower limit switch activation will often be averaged to reduce errors associated with variable input conditions, such as line debris, changes in density in fluid to be injected density, and any other changes that may affect pressure drop or overall system pressure.

The operator may use the information gathered from electronics module 40 or the monitoring equipment in a number of ways. Typically, the information is used for inventory control purposes, signaling the operator when to procure more fluid to be injected. The information may also serve as an ongoing indicator that the pump is functioning and injecting the fluid. Further, the information generated may show that the fluid being injected is entering the second fluid at the desired rate. The operator may also use the information to find potential leaks in CIPG 10 upstream of metering reservoir 30 by comparing the volume change within chemical holding tank 20 and the amount measured by metering reservoir 30.

The orientation, size, and construction of the process equipment delineated may vary depending on individual process conditions and can be determined by one of ordinary skill in the art. Also, where temperatures and pressures are indicated, those given are a guide to the most reasonable and best conditions presently known for those processes, but temperatures and pressures outside of those ranges can be used within the scope of this invention. The range of values expressed as between two values is intended to include the value stated in the range.

What is claimed is

1. A flow measuring apparatus comprising:
a) a metering reservoir, the metering reservoir having a volume, a reservoir inlet port, a reservoir outlet port, a top and a bottom;
b) a control valve, the control valve capable of allowing or stopping liquid from entering the metering reservoir;
c) a liquid level sensor, the liquid level sensor located so as to able to sense a fluid level within the metering reservoir and operably connected to an upper limit switch and a lower limit switch, the upper limit switch having an upper set point and the lower limit switch having a lower set point; and
d) an electronics module, the electronics module in electrical communication with the upper limit switch and the lower limit switch and further in electrical communication with the control valve.

2. The flow measuring apparatus of claim 1 wherein the upper set point is located at the top of the metering reservoir.

3. The flow measuring apparatus of claim 1 wherein the lower set point is located at the bottom of the metering reservoir.

4. The flow measuring apparatus of claim 1 wherein the liquid level sensor comprises a float.

5. The flow measuring apparatus of claim 4 wherein the liquid level sensor further comprises a vertical guide, the vertical guide attached to the top of the metering reservoir and the bottom of the metering reservoir, and further wherein the float is capable of transversing the guide vertically.

6. The flow measuring apparatus of claim 1 wherein the reservoir inlet port is located at the top of the metering reservoir.

7. The flow measuring apparatus of claim 1 wherein the reservoir inlet port is located at the bottom of the metering reservoir.

8. The flow measuring apparatus of claim 1 wherein the volume of the metering reservoir between the upper set point and the lower set point has an error tolerance of less than 1%.

9. The flow measuring apparatus of claim 8 wherein the volume of the metering reservoir between the upper set point and the lower set point has an error tolerance of less than 0.1%.

10. The flow measuring apparatus of claim 1 wherein the metering reservoir volume is less than one gallon.

11. The flow measuring apparatus of claim 10 wherein the metering reservoir volume is less than one quart.

12. The flow measuring apparatus of claim 1 wherein the metering reservoir is rectangular or cylindrical.

13. The flow measuring apparatus of claim 1 wherein the metering reservoir further comprises a breather vent, the breather vent located on the top of the metering reservoir.

14. The flow measuring apparatus of claim 1 further comprising a power supply, the power supply capable of supplying power to the electronics module.

15. The flow measuring apparatus of claim 14 wherein the power supply comprises a battery, a solar panel, or current converted to a 12-volt dc power level.

16. The flow measuring apparatus of claim 1 further comprising a pump, the pump capable of removing fluid from the metering reservoir through the metering reservoir outlet port.

17. A flow measuring apparatus comprising:
a) a metering reservoir, the metering reservoir having a volume, a reservoir inlet port, a reservoir outlet port, a top and a bottom;
b) a tank outlet conduit, the tank outlet conduit capable of conducting fluid to the reservoir inlet port;
c) a control valve, the control valve capable of allowing or stopping liquid from flowing from entering the metering reservoir;
d) a liquid level sensor, the liquid level sensor located so as to able to sense a fluid level within the metering reservoir and operably connected to a lower switch, the lower limit switch having a lower set point;
e) a paddlewheel, the paddlewheel having a central pivot point and paddles, the paddles radiating from the central pivot point, the paddles capable of rotating about the central pivot point, the paddlewheel located within the tank outlet conduit and capable of rotating in response to fluid flow through the tank outlet conduit; and
f) an electronics module, the electronics module in electrical communication with the paddlewheel and the lower limit switch and further in electrical communication with the control valve.

18. The flow measuring apparatus of claim 17 wherein the lower set-point is located at the bottom of the metering reservoir.

19. The flow measuring apparatus of claim 17 wherein the liquid level sensor comprises a float.

20. The flow measuring apparatus of claim 19 wherein the liquid level sensor further comprises a vertical guide, the vertical guide attached to the top of the metering reservoir and the bottom of the metering reservoir, and further wherein the float is capable of transversing the guide vertically.

21. The flow measuring apparatus of claim 17 wherein the reservoir inlet port is located at the top of the metering reservoir.

22. The flow measuring apparatus of claim 17 wherein the reservoir inlet port is located at the bottom of the metering reservoir.

23. The flow measuring apparatus of claim 17 wherein the volume of the metering reservoir has an error tolerance of less than 1%.

24. The flow measuring apparatus of claim 23 wherein the volume of the metering reservoir has an error tolerance of less than 0.1%.

25. The flow measuring apparatus of claim 17 wherein the metering reservoir volume is less than one gallon.

26. The flow measuring apparatus of claim 25 wherein the metering reservoir volume is less than one quart.

27. The flow measuring apparatus of claim 17 wherein the metering reservoir is rectangular or cylindrical.

28. The flow measuring apparatus of claim 17 wherein the metering reservoir further comprises a breather vent, the breather vent located on the top of the metering reservoir.

29. The flow measuring apparatus of claim 17 further comprising a power supply, the power supply capable of supplying power to the electronics module.

30. The flow measuring apparatus of claim 29 wherein the power supply comprises a battery, a solar panel, or current converted to a 12-volt dc power level.

31. The flow measuring apparatus of claim 17 further comprising a pump, the pump capable of removing fluid from the metering reservoir through the metering reservoir outlet port.

32. A flow measuring apparatus comprising:
a) a holding tank, the holding tank having a height, a bottom, and a holding tank outlet port;
b) a metering reservoir, the metering reservoir in fluid communication with the holding tank and further having a volume, a reservoir inlet port, a reservoir outlet port, a top and a bottom;
c) a control valve disposed between the holding tank and the metering reservoir, the control valve capable of allowing or stopping liquid from flowing from the holding tank to the metering reservoir;
d) a liquid level sensor, the liquid level sensor located so as to able to sense a fluid level within the metering reservoir and operably connected to an upper limit switch and a lower switch, the upper limit switch having an upper set point and the lower limit switch having a lower set point; and
e) an electronics module, the electronics module in electrical communication with the upper limit switch and the lower limit switch and further in electrical communication with the control valve, the electronics module so configured as to be able to receive notification of activation of the upper limit switch and the lower limit switch, and further configured so as to be able to direct the opening or closing of the control valve and to monitor the activation of the lower limit switch and upper limit switch.

33. The flow measuring apparatus of claim 1 wherein the holding tank outlet port is located at the bottom of the holding tank.

34. A method of measuring a small volume flow comprising:
a) providing a flow measuring apparatus, the flow measuring apparatus comprising a holding tank, the holding tank having a height, a bottom, and a holding tank outlet port; a metering reservoir, the metering reservoir in fluid communication with the holding tank and further having a volume, a reservoir inlet port, a reservoir outlet port, a top and a bottom; a control valve disposed between the holding tank and the metering reservoir, the control valve capable of allowing or stopping liquid from flowing from the holding tank to the metering reservoir; a liquid level sensor, the liquid level sensor located so as to able to sense a fluid level within the metering reservoir and operably connected to an upper limit switch and a lower limit switch, the upper limit switch having an upper set point and the lower limit switch having a lower set point; and an electronics module, the electronics module in electrical communication with the upper limit switch and the lower limit switch and further in electrical communication with the control valve;
b) providing a fluid within the holding tank, the fluid in the holding tank having a volume;
c) opening the control valve to allow fluid flow between the holding tank and the metering reservoir;
d) filling the metering reservoir with the fluid until the upper limit switch is activated;
e) closing the control valve to stop fluid flow between the holding tank and the metering reservoir;
f) emptying the metering reservoir of fluid until the lower limit switch is activated; and
g) measuring the fluid emptied from the metering reservoir.

35. The method of measuring a small volume flow of claim 34 wherein the step of calculating the fluid emptied from the metering reservoir is accomplished with the electronics module or separately located monitoring equipment.

36. The method of measuring a small volume of flow of claim 35 further comprising:
calculating the volume of fluid in the holding tank.

37. The method of measuring a small volume flow of claim 34 further comprising:
powering the electronics module with a battery, a solar panel, or current converted to a 12-volt dc power level.

38. The method of measuring a small volume flow of claim 34 further comprising after step (f):
injecting the fluid into a second fluid.
